(19) United States
(12) Patent Application Publication
(10) Pub. No.: US 2009/0327888 A1
(43) Pub. Date: Dec. 31, 2009

(54) COMPUTER PROGRAM FOR INDENTIFYING AND AUTOMATING REPETITIVE USER INPUTS

(75) Inventors: Tod M. Woolf, Sudbury, MA (US); Andrew S. Marks, Wayland, MA (US)

Correspondence Address: LAHIVE & COCKFIELD, LLP;FLOOR 30, SUITE 3000, ONE POST OFFICE SQUARE, BOSTON, MA, 02109, US

(73) Assignee: IPIFINI, Inc., Sudbury, MA (US)

(21) Appl. No.: 11/915,776

(22) PCT Filed: May 30, 2006
(86) PCT No.: PCT/US06/20980

§ 371 Date: Aug. 27, 2009

Related U.S. Application Data
(60) Provisional application No. 60/595,034, filed on May 31, 2005.

(51) Int. Cl. G06F 3/01

(52) U.S. Cl. 715/704

(57) ABSTRACT

The invention relates to machine-readable code that tracks user input and associated computer output during use of a computer programmed with the code, identifies repetitive patterns and automates the user input portion of those identified repetitive patterns when they occur again.

### RELATED APPLICATION INFORMATION

This application claims priority to and the benefit of a United States Provisional Application entitled “Computer Program for Identifying and Automating Repetitive User Inputs”, filed May 31, 2005, Application No. 60/595,034.

### TECHNICAL FIELD OF THE INVENTION

The illustrative embodiment of the present invention relates to machine-readable code that tracks user input and associated computer output during use of a computer programmed with the code, identifies repetitive patterns and automates the user input portion of those identified repetitive patterns when they occur again.

### BACKGROUND OF THE INVENTION

In today's highly computerized world, repetitive stress syndrome for computer users is common. It occurs among those who type frequently or use a computer mouse extensively. This injury is exacerbated when the typing and mouse movements are repeated many times. A similar problem can also occur with other electronic devices, particularly those with small keyboards used for e-mailing and text messaging, such as cell phones and PDAs.

Repetitive mouse movement and keyboard strokes are often required for certain computer tasks, such as extensive cutting and pasting within or between software applications. In addition, many computer users perform the same tasks on a daily or more frequent basis either because of routine or the demands of their work. Many software programs provide the user with the ability to program multiple keystrokes, menu selections and mouse movements in a small routine called a macro. The user may then invoke the macro to repeat those same keystrokes, menu selections and/or mouse movements. The macro is invoked as a menu item, via a special keystroke or by movements. The macro is invoked as a menu item, via a special keystroke or by pressing a button within the software.

Unfortunately, even the most frequent users of software programs that allow for the creation of macros never take advantage of this potentially time- and stress-saving feature. This is because the macro feature is typically misunderstood and requires the user to realize, before execution, that a series of inputs will be repeated in the future and therefore need to be recorded in order to program a macro. The user must manually terminate the recording process. This requires the user to properly choose the last input present in the macro and to remember to stop the recording process.

There does exist stand-alone software that will record inputs within and between multiple programs running on a computer and create macros thereform. However, these programs also require the user to identify the need for a macro and turn on the macro recorder before executing the input string.

Once a macro is invoked it performs the recorded inputs once. If the user desires the input to be repeated again, they must once again invoke the macro. Many computer users require that a series of inputs be repeated multiple times during the course of a task, such as constant cutting and pasting between applications. It is inconvenient for the user to invoke the recorded macro for each repetition.

Other repeated routines performed by a user on a computer are also capable of being automated through the features of the operating system. For example, the opening of applications upon the powering on of a computer can be automated in Windows® by placing the programs or shortcuts thereto in the startup folder. The preferential choice of a printer may be achieved through the designation of that printer as the default in the Control Panel of Windows®. Not surprisingly, the vast majority of users are unaware of these automating feature or do not understand how they work.

It would be highly advantageous to have software that identified repetitive patterns of input performed by the user and associated computer output and offered the user the choice to convert those repeated patterns to a macro or other routine that can be automatically implement the user input portion of those patterns in the future. It would be further desirable if such a software program provided the user with the option of invoking that repeated pattern several times in succession without requiring the user to input the command to invoke that pattern each time.

### SUMMARY OF THE INVENTION

The present invention provides machine-readable instructions that continually monitor input to a computer by a user, as well as computer-generated output that triggers user input and computer-generated output produced as a result of user input (collectively referred to as “associated computer output”). The present invention identifies any repetitive input pattern and is capable of automatically reproducing the identified pattern. The present invention analyzes the input and associated output to identify a repetitive pattern. When a repetitive pattern is identified, it can be stored and compiled into a macro, applet, routine or subroutine wherein the user input portion of the repetitive pattern can be automatically invoked.

In one embodiment the invention provides a computer-readable medium containing instructions for controlling a computer process to enable: a) the recordation of user input and associated computer output; b) the analysis of said input and output to identify a repetitive pattern; and c) the compilation and storage of said identified repetitive pattern for automated replay of the user input portion of said pattern at a later time.

In a preferred embodiment, the computer-readable medium further comprises instructions for controlling a computer process to enable the display of a user interface through which a user controls one or more of said recording, analysis, compilation, storage or replay.

In another embodiment, the invention provides a system for identifying a repetitive pattern of user input and associated computer output and automating the user input portion of said pattern, said system comprising: a) a computer operative to receive user input from an input device; b) said input device in communication with said computer; and c) software stored on tangible, computer-readable medium in communication with said computer, wherein the software comprises machine readable code that when executed by a processor records said user input and associated computer output, analyzes said user input and computer output to identify a repetitive pattern; and compiles and stores said repetitive pattern for replay of the user input portion at a later time.

In a preferred embodiment the system further comprises a display in communication with said computer; and said software provides a user interface outputted to said display through which a user controls one or more of said recording, analysis, compilation, storage or replay.

In yet another embodiment, the invention provides a method for identifying a repetitive pattern of user input and associated computer output and automating the user input portion of said pattern, said method comprising the steps of: a) recording user input from an input device in communication with a computer and associated computer output; b) analyzing said input and output to identify a repetitive pattern; and c) compiling and storing said repetitive pattern in a storage device or memory in communication with said computer; d) replaying the user input portion of said repetitive pattern.

In a preferred embodiment, the method further comprises the step of: e) providing a user with a user interface through which the user controls one or more of said recording, analysis, compilation, storage or replay.

The present invention is distinct from current automating features such as autofill or password manager functions, in that the machine-readable instructions are universally applicable through all input functions, regardless of any particular program or form into which the input is entered. The code, system and method of the present invention are not dependent upon specific coding for each type of repetitive pattern. The present invention can recognize patterns between diverse software programs, operating systems and peripheral devices connected to a computer or a network.

### BRIEF DESCRIPTION OF THE DRAWINGS

FIG. 1 depicts an environment suitable for practicing the illustrative embodiment of the present invention;

FIG. 2 is a flowchart of a sequence of steps followed by the illustrative embodiment of the present invention to identify and replicate a repetitive pattern of user input;

FIG. 3A depicts an example of a series of 27 consecutive input and associated computer output events by the illustrative embodiment of the present invention; and

FIG. 3B depicts an example of the analysis of the input and associated computer output events of FIG. 3A by the present invention.

### DETAILED DESCRIPTION OF THE INVENTION

The term “computer” as used herein, includes any electronic device that comprises a processor and can receive input. This includes, but is not limited to, laptop and desktop computers, cell phones, PDAs, computerized appliances, ATM machines, VCRs, DVD players and recorders, digital music recorders, printers, facsimile machines, smart keyboards, scanners, GPS navigation devices, computers or chips that control vehicle functions, voice prompt systems, weapon system controllers, gaming devices, device-specific and universal remote control units, and the like.

A “computer-generated output that triggers user input” according to this invention is any computer-generated output that requests or requires user input. For example, such computer generated output may prompt the user for input in order to complete, continue or end a routine; to close a window or a program; during software or hardware installation or the like. Examples of such computer-generated output include, but are not limited to, dialog boxes, pop-up windows (including internet pop-up advertisements), error messages, confirmation boxes (e.g., yes/no, agree/disagree and continue/cancel boxes), and audio and voice prompts (such as in telephonic voice prompt systems).

The term “computer-generated output produced as a result of user input” as used in this invention includes any automated computer activity that has been pre-programmed and is invoked by a user and any computer activity that is carried out as a result of some initiating input by the user. For example, a user may log onto an e-mail account (user input) and the e-mail program then informs the user that they have mail (computer-generated output produced as a result of the user input). Both the logging on to the e-mail account and the subsequent computer-generated message that the user has mail are recorded and analyzed for repetitive patterns by the machine-readable code of this invention.

Computer-readable instructions for recording user input and associated computer output are well-known in the computer art and are currently present in most software that allows the recording of macros, as well as in stand alone software that is commercially available. The term “user input” as used herein means any combination of keystrokes, relative and absolute mouse movements, relative and absolute cursor movements, voice commands, API calls, the opening and closing of other software programs, the shifting of focus between software programs residing in a computer memory (and available to the user), the powering on or off of a computer, the activation of other switches or buttons on a computer, the initiation of pre-existing macros, the connection to, disconnection from, activation of switches or buttons on, or control of peripheral devices connected to a computer, or any other activities a computer is capable of carrying out upon input by a user.

The term “absolute” movement refers to an X-Y coordinate system corresponding to the screen upon which a cursor appears. The term “relative” movement refers to the displacement of a cursor from a specified location within a program. For example, the movement of a cursor two rows down and two columns to the left of a previous location in a spreadsheet; or the movement of a cursor two pages down or six lines up in a word processing program are both relative movements.

The recorded input and associated computer output may be input that occurs on either the computer on which the software of this invention is installed or another computer connected via a network to the computer on which the software of this invention is installed.

The term “input device” includes, but is not limited to, keyboard, such as a computer keyboard, chorded keyboard or keypad (including a telephone keypad); a pointing device, such as a computer mouse, trackball, touchpad, trackpad, joystick, pointing stick, graphics tablet (or digitizing tablet), stylus, light pen, light gun, Zapper Light Gun (Nintendo Entertainment System); cyberglove, touch screen, head pointer, or eye gaze/eye tracking; a game controller such as a gamepad (or joypad), or paddle; a Power Pad; a digital camera, including a web cam; an image scanner; a voice activated input system; a peripheral device, such as a printer; another computer connected via a network; or a peripheral device connected to another networked computer. The device may be in communication with the computer via a direct, wired connection, through a wireless connection or through the internet.

The term “network” as used herein, means a system of two or more computers connected via a Local Area Network (LAN), Wide Area Network (WAN) or the Internet through a variety of connections including, but not limited to, standard telephone lines, LAN or WAN links (e.g., 802.11, T1, T3, 56 kb, X.25), broadband connections (e.g., ISDN, Frame Relay, ATM), cluster interconnection (Myrinet), peripheral component interconnections (PCI, PCI-X), wireless connections, or some combination of any or all of the above.

The recorded input and associated computer output can be stored in the working memory of and/or on a storage device connected to that computer or another computer in a network. The location of the storage need only be accessible for analysis by the machine-readable code that identifies repeated input patterns. In one embodiment, the recorded input and output is encrypted for security and can only be accessed via a password or other secure mechanism. In some embodiments, there are limitations on how long in time recorded events should be saved and used for comparison, the number of individual input and output events that should be saved and searched for comparison and/or the size of disk or memory storage space past input and output events are allowed to occupy. These restrictions help reduce analysis time, as well as reducing the identification of “false positive” repetitive patterns (i.e., patterns that are not desired for automation).

In another embodiment, context information related to user input and associated computer output may also be recorded. This may include the time, date, day of the week (including holiday or non-holiday status) that the input occurred; the time after the computer was powered on that the input occurred; the identity of the user as determined by login, security cards, caller ID, account number, password or RFID; quantitative or qualitative information about the user stored in the computer or on the network (e.g., how much money is in an account as indicated in personal financial management software); what other software programs were resident in the memory of the computer or other computers in the network during the input; the status of peripheral devices connected to the computer or the network during the input; the identification of other computers active on the network during the input; the network connection status of the computer into which input is being entered; the geographic location of the user (as determined by GPS or other methods); environmental status at the user's location (both indoors and outdoors), such as temperature, amount of ambient light or sound, relative humidity, precipitation, wind speed and direction; emergency or alert status; information related to certain portions of the input (e.g., the sender of an e-mail, who called on the phone (based on caller id), the name of a file that is opened or selected, the properties of a file that is opened or selected); whether the computer is docked or not, the physical speed at which the computer is moving (e.g., how fast a car is going); the altitude of the computer (e.g., the altitude of an airplane); information relating to memory or power overload, such as the number of windows open, the number of programs running, the amount of battery power remaining, the performance level of the computer, the amount of hard disk available; or the status of a device which is controlled by the computer (e.g., the gear a car is in, the locked or unlocked state of a door, whether the windshield wipers are off or on and the speed of the wipers, the various states of a cell phone). The analysis for repetitive patterns may utilize this context information to compare user input and associated computer output in identifying a repetitive pattern.

In order to analyze and accurately identify a repetitive pattern according to this invention, the length of the string of events to analyze or “search string sampling window” (e.g., number of individual inputs and associated computer outputs) must be set. This may be achieved through a default setting or may be user-definable. This window defines how the analysis is carried out. For example, if the window is set at 4, there are 3 different strings analyzed in a series of six events (e.g., 1-2-3-4, 2-3-4-5, and 3-4-5-6).

In addition, the number of times that a matching string is found in the past recording of inputs and outputs in order to be recognized as a repetitive event must also be set. This, too, can be set as a default or may be user-adjustable. Typically, a matching string of events should be found once, twice, three or four times in the recorded data in order to be identified as a repetitive event. As the length of the search string sampling window increases, the matches required for identifying a repetitive event decreases.

The analysis of recorded input and associated computer output for matching strings and identifying repetitive patterns may employ any pre-existing pattern recognition technology and algorithms for comparing packets of information and identifying homologies or exact matches. In one embodiment, the analysis is a simple “find” function that searches for identical matches against a series of recorded user inputs and associated computer outputs. This would suffice for identifying a large number of relevant repetitive patterns.

The term “repetitive pattern” does not require a 100% identity between input and associated computer output strings. Fuzzy logic, homology cutoffs, or other criteria can be used by the computer code of this invention to determine if two input and associated computer output strings (optionally together with context information) are sufficiently identical to warrant being identified as repetitive. The analysis with respect to less than 100% identity between two series of inputs and associated computer outputs may typically employ one or more of the additional types of context information recorded. For example, if the context is a particular time of day, the machine readable code may analyze only those strings that occurred within 30 minutes of that time of day. With stricter context requirements, the machine-readable code might allow for a lesser degree of identity in identifying a match if, for example, the strings all occurred within 30 minutes of the same time of day.

In particular the identification of a repetitive pattern may be based on high homology between computer-generated outputs that trigger user input; high homology between user inputs, high homology between the results produced by user inputs (e.g., the computer output produced as a result of user input), or any combination thereof.

Means for identifying repetitive patterns of varying homologies are well-known in the art and include, but are not limited to, John Shawe-Taylor & Nello Cristianini, “Kernel Methods for Pattern Analysis,” Cambridge University Press, 2004; Agrep, Aho-Corasick algorithm, Boyer-Moore string search algorithm, Fuzzy string searching, Hash function, Knuth, Morris-Pratt algorithm, Rabin-Karp string search algorithm, Blast, Blast N and Blast X.

In a preferred embodiment, once a repetitive pattern has been identified, the user interface presents the user with a series of queries to determine the accuracy of that identification. The user's responses to these queries are used to further adjust the parameters of the analysis to more accurately detect repetitive patterns in the future. In other words, the computer code that carries out the analysis is “smart” and modifies its parameters based upon successes and failures in accurately identifying a repetitive pattern for each user.

In an alternate embodiment, the user can adjust various parameters of the analysis through the user interface. These adjustments may be achieved through the use of on-screen dialog boxes, check boxes, sliders or other configuration mechanisms that may be presented to the user from the user interface. Through these adjustments, the user can control the frequency and accuracy with which a repetitive pattern is identified. Examples of user-adjustable parameters include, but are not limited to, the inclusion or exclusion of certain classes or categories of input; the inclusion or exclusion of certain classes of associated computer output; the extent to which context information is used; the length of the search string sampling window; the number of times a matching string has previously occurred; the minimum degree of identity between two series of inputs and associate computer output required for characterization as a match or “repetitive”; the relative weights to be given to input versus associated computer output; or the extent to which the program adjusts parameters based upon its prior successes or failures in correctly identifying a repetitive pattern. Many of these adjustments can also be made automatically by the program of this invention based upon responses to user queries.

Once the software program of this invention has tentatively identified a repetitive pattern, the user interface alerts and queries the user as to whether the repetitive pattern should be compiled and stored. The query may describe textually the input and associated computer output in the pattern. In some embodiments, the software program of this invention may graphically demonstrate the repetitive pattern by running an animation of the input and the associated computer output. For example, in identifying an input string causing the cutting of cells from a spreadsheet program and their subsequent pasting into a word processing program the software will graphically display the cells being selected, the execution of a copy command through the spreadsheet software menu or button bar, the switching of focus to the word processing program through a cursor click in the word processing program space, the positioning of the cursor in the word processing program at the desired paste site, the execution of a paste command through the word processing program menu or button bar, and the appearance of the copied cells at the paste site in the word processing document.

The animated graphical display of the input and output of the repetitive pattern allows the user to clearly understand what will be compiled and stored. In a preferred embodiment, the graphical display also advantageously allows the user to include or exclude each of the steps of the input string in the recording. In one embodiment, the user interface offers the user the options of: 1) not compiling and storing the identified repetitive pattern; 2) editing the repetitive pattern prior to compiling and storing; or 3) compiling and storing the repetitive pattern as identified. Once the user chooses to compile and store the original or edited repetitive pattern, the user interface offers multiple ways to invoke the user input portion of the pattern in the future. One way is to enable user execution through a shortcut, such as a button, a hotkey, a menu item or other means for the user to invoke the compiled and stored pattern. In the case of a button, a tiny screen next to the button or a pop-up window or balloon help object may describe the macro to allow to know what automated input is triggered by the button.

Another means for invoking the user input is through user initiation, which triggers automatic completion of the pattern. This requires the user to begin to input the pattern. The machine readable code of this invention compares the user input to the compiled and stored patterns and upon identifying an exact match either automatically completes the pattern or generates a dialog box through the user interface querying the user as to whether the remainder of the pattern should be invoked.

The user's response to the query “trains” the machine-readable code as to how much of the pattern is necessary to input in order to automatically complete the pattern. Thus, dialog boxes and user queries are not necessary for automatic completion following one or more invocations of the repetitive pattern via this method.

In repetitive patterns that are initiated by computer output (i.e., computer-generated output that triggers user input), the user input portion may be invoked automatically upon the occurrence of said initiating computer output. Alternatively, the occurrence of the initiating output triggers a dialog box and query that asks the user if the pattern should be completed. The dialog box may also ask the user if the pattern should always be completed in the future upon the occurrence of the particular initiating computer output. A positive response to such a query eliminates the need for a user response and fully automates future invocations of that repetitive pattern.

In one embodiment, when a repetitive pattern occurs close in time, the user interface offers the user the ability to automatically perform the repetitive pattern multiple times. This typically occurs when the repetitive pattern contains recognizable and regular variables, such as a simple progression. Such repetitive patterns will be identified by the machine readable code of this invention. For example, the machine-readable code records the selection of cells A1:A3 from a spreadsheet, the copying of those cells and the pasting of the copied cells into a word processing document, the selection of cells B1:B3 from the same spreadsheet, the copying of those cells and the pasting of B1:B3 immediately following the pasted cells A1:A3 in the same word processing document. This is identified as a repetitive pattern. The user interface alerts the user of the repetitive pattern. The small (or no) time lapse between the detected repetitive patterns triggers the user interface to offer the user an option to continue selecting, copying and pasting the first three cells in each consecutive column of the spreadsheet into the word processing document for a user-defined number of cycles. If the user selects this option, the pattern is compiled and carried out (with storage of the pattern initially occurring in memory) as defined by the user.

The analysis code can also detect interruptible repetitive patterns. An interruptible repetitive pattern is a pattern that includes a call for a variable user input within the sequence of otherwise repetitive inputs and associated computer outputs. For example, such a repetitive pattern may be the opening of a master file, the selection of a portion of that file for copying, the pasting of the selected portion in a new file, the saving of the new file with a user-defined file name and the return of focus to the master file. The user-defined file name will be different for each copy and paste operation. Accordingly, the return of focus to the master file requires the user to name the new file. However, the input both before and after the file naming represents a repetitive pattern that is recognized by the machine-readable code of this invention.

The compilation of the repetitive pattern may be modified based upon the responses to user queries (such as deleting or altering certain individual events within the input string) described above. Once modified, an executable compilation of the repetitive pattern is created in the form of a macro, applet, routine or other series of commands and controls that allows a user to invoke the user input portion of the modified repetitive pattern with few, or more preferably one, keystrokes or mouse clicks. Alternatively, the repetitive pattern can be automatically invoked by initiating a portion of the repetitive pattern in the appropriate context. In another embodiment, the initiation of a portion of a stored repetitive pattern causes the user interface to present a dialog box querying the user as to whether that repetitive pattern should be invoked. When the pattern involves associated computer output that triggers user input, the pattern can be automatically invoked upon the occurrence of that input-triggering output.

The executable compilation may be generated in any programming language that is compatible with the operating system running the software program of this invention. Such programming languages include, but are not limited to, AppleScript, BASIC, C++, Cobol, Delphi, HTML script, JavaScript, Fortran, Visual Basic, Visual DialogScript, and Rexx. In a preferred embodiment, the executable compilation is encrypted for security and may only be accessed via a password or other secure mechanism.

The nature of the executable compilations can vary widely. At a very basic level, strings of typed letters, number or combinations thereof are candidates for repetitive patterns and can be compiled into an executable routine that performs the user input portion of that pattern. At the other end of the spectrum, processes involved in the maintenance, updating and management of a network of hundreds of computers can also be identified as a repetitive pattern and compiled into an executable routine by the software of the present invention. In a preferred embodiment, the length of the search string sampling window is different for different classes of input. Input that is likely to produce fortuitous matches, such as text input (e.g., typing) has a larger search string sampling window. More complicated input, such as the checking for a plurality of network computers for viruses requires a shorter search string sampling window.

Any repetitive input string performed by a user on a computer and its associated computer output can be converted into an executable compilation by the machine-readable code of this invention. Some of the more basic inputs that can be converted include, but are not limited to, one or more of: cutting/copying and pasting within or between multiple software applications, closing unwanted pop-up boxes, error messages or dialog boxes, deleting junk mail, multiple sorting of data in and between applications, overriding API calls, saving of e-mail attachments or other files to specific directories, attaching files from specific directories to e-mails, choosing a printer or other peripheral device, altering the view properties in a program, start-up and shutdown of multiple programs.

Other types of input that can be automated by the machine readable software of this invention include, but are not limited to input associated with accounting software; input associated with the use of an automated teller machine; input associated with gaming devices; input related to theater or concert control (e.g., lights, audio, stage effects); input associated with home automation systems; input used in ship control systems or aircraft control systems; input associated with personal on-line brokerage or security trading systems; input related to other websites, such as shopping sites, technical support sites, product sites, informational sites, etc.; input associated with systems that assist impaired persons; construction equipment controllers, including preferably input used to control heavy machinery such as a crane; input into voice activated messaging and informational systems, such as telephonic systems that offer menus and submenus and require the user to select menu items to move to the next menu; input associated with the operation of motor vehicles, including automobiles and, preferably, motorcycles (dangerous to push buttons while riding); input related to factory control systems; input associated with electronic gambling devices; input associated with fuel pumping stations (e.g., always choose regular, fill it up, and don't request a receipt); automatic golf caddy input; input used in exercise equipment control systems; input associated with appliances, such as laundry machines, refrigerators, coffee/espresso makers, ovens, microwaves, etc.; input associated with medical research and diagnostic assay equipment (and computers controlling the same); input associated with air traffic control equipment; input associated with personal electronic devices, such as cell phones, PDAs, digital music players and recorders, alarm clocks, etc.; cash register inputs; input associated with thermostatic and/or environmental controllers; input associated with software, such as word processing programs, graphics and drawing programs, CAD programs, spreadsheets, database interfaces; input related to software writing tools; electronic musical instrument inputs; and inputs used in conjunction with smart peripheral devices, including the input device themselves (e.g., a smart keyboard).

The user interface of the software program of this invention is preferably a graphical user interface, but could also be audio (such as a telephone auto attendant or pure voice commands). In one embodiment, the interface has a standard mode and an advanced mode. In the standard mode, the interface appears when a repetitive pattern is detected, informing the user of the nature of the pattern and offering the user the option of viewing an animated demonstration of the steps in the pattern. The interface queries the user as to whether they desire to automate some or all of the user input portion of the pattern with or without modification. In one embodiment, if the user chooses not to compile this pattern, the software queries the user further and modifies the analysis parameters based on the answers to avoid identifying similar strings as repetitive patterns in the future.

If the user desires to compile the repetitive pattern, the user interface provides the user with an option to edit (change, delete or add input to) the pattern. This may be achieved by a series of queries or prompts concerning portions of the repetitive pattern, preferably during or immediately following the animated demonstration. In another embodiment, the answers to these queries are used to further refine parameters for identifying repetitive patterns.

Once the user is satisfied with the pattern to be compiled, the user interface offers the user options for invoking the compiled pattern in the future. Such options may include, but are not limited to, a button or icon placed on the operating system or individual program toolbar, information bar or menu; a keyboard shortcut; a menu item; the performance of a user-defined or default number of initial steps of the repetitive pattern; the initiation of the repetitive pattern followed by a response to a dialog box invoked by said initiation; or where the pattern includes the occurrence of computer-generated output that trigger a user response, automatically upon the occurrence of that computer-generated output.

In the advanced mode the user interface allows the user to manually adjust parameters for recording, analysis, compilation, storage and invocation. Adjustments to the recording and analysis modes are discussed above. In the advanced mode, the executable compilations produced may be edited directly by the user. Furthermore, the user in this mode can control the location and length of time of storage of the executable compilations. The advanced mode also may allow the user to control the user interface itself. For example, the user can adjust the extent to which the software interacts with the user, the number and types of queries that are presented, and other aspects of the user interface. The advanced mode may also allow the user to change the parameters that trigger the invocation of the pattern (e.g., the amount of the pattern that needs to be inputted by the user before it is automatically completed or a dialog box is presented).

Certain embodiments of the present invention are described below. It is, however, expressly noted that the present invention is not limited to these embodiments, but rather the intention is that additions and modifications to what is expressly described herein also are included within the scope of the invention. Moreover, it is to be understood that the features of the various embodiments described herein are not mutually exclusive and can exist in various combinations and permutations, even if such combinations or permutations are not expressly made herein, without departing from the spirit and scope of the invention.

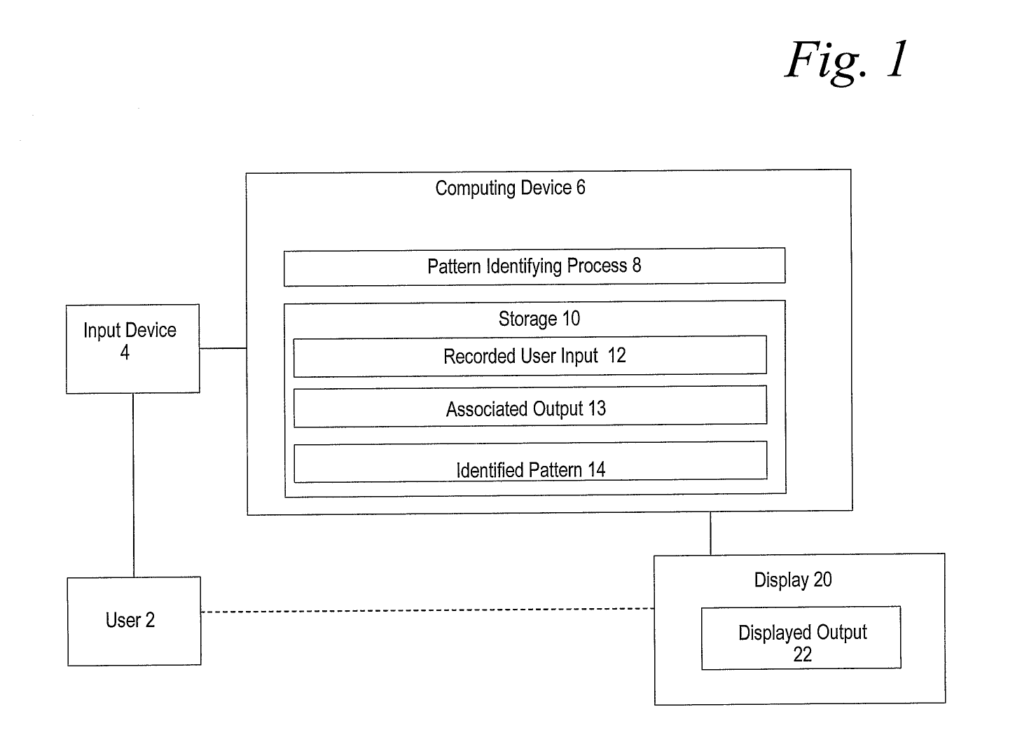

FIG. 1 depicts an environment suitable for practicing the illustrative embodiment of the present invention. A user 2 accesses an input device 4 that is communicating with a computing device 6. The computing device 6 executes a pattern identifying process 8 that identifies and replicates repetitive user inputs. The computing device 6 is in communication with a display 20 upon which displayed output 22 that is generated from applications and processes executing on the computing device is displayed. The computing device 6 also includes short and/or long term storage 10 in which recorded user input 12 and associated computer output 13 is stored. The storage 10 also stores identified user input and associated computer output patterns 14 that have been detected by the pattern identifying process 8 may be stored. The pattern identifying process 8 allows a user to programmatically replicate the identified user input pattern 14 at a user's request.

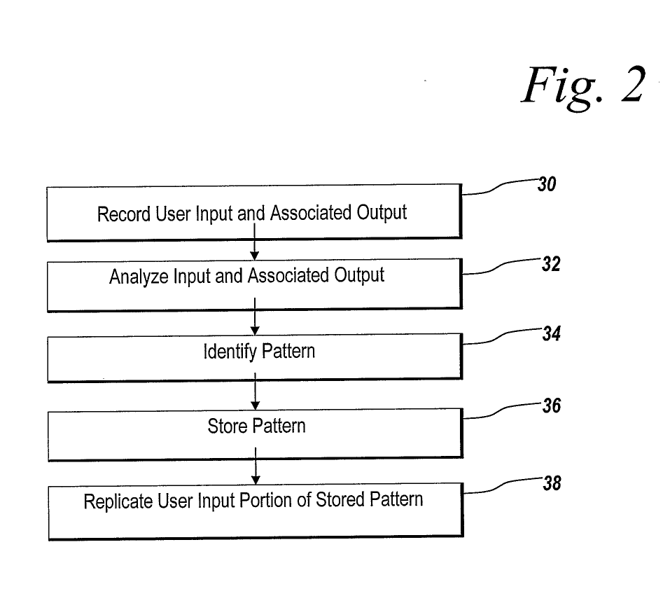

FIG. 2 is a flowchart of the sequence of steps followed by the illustrative embodiment of the present invention to identify and replicate user input patterns. The sequence begins with the present invention recording user input 12 and associated computer output 13 (step 30). The pattern identifying process 8 then analyzes the recorded input 12 and associated output 13 (step 32) and identifies repetitive patterns as described above (step 34). Any identified patterns 14 are stored in storage 10 (step 36). Subsequently, the user 2 may utilize the pattern identifying process 8 to replicate the user input portion of the stored pattern 14 (step 38). It will be appreciated that the pattern identifying, pattern storing and pattern replicating may be carried out by separate processes rather than a single process without departing from the scope of the present invention.

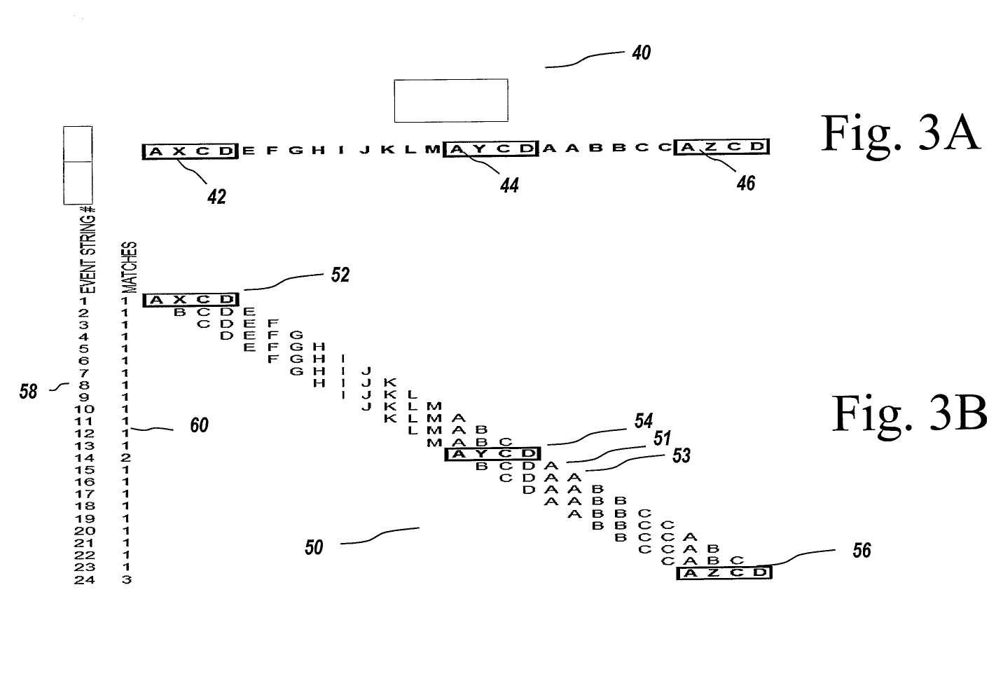

In FIG. 3A, a series of twenty-seven consecutive input and associated computer output events 40 are depicted, wherein a letter corresponds to each event. The parameters for the analysis of this event string set the search string window at 4 events and indicate a match when 3 out of 4 events in a string are identical to a previous string. Search windows 42, 44 and 46 are illustrated. The analysis identifies a repetitive pattern after detecting a third match in the event log.

FIG. 3B depicts each of the twenty-four event strings 50 analyzed by the machine readable code of this invention and the number of times that event string is identified as a match to another string under the above-described parameters. A column 58 indicating the event string number and a column 60 indicating the corresponding number of matches for each event may be provided. Event string “No. 14” (54) is detected as a match to event string “No. 1” (52) because events A, C and D in each string align. For clarity purposes, it should be understood that the order of events must be the same for alignment. Therefore, event string “No. 16” (53) does not match event string “No. 15” (51) despite both containing events C, D and A because those events do not occur at the same position in the two event strings. Event string “No. 24” (56) is a match to event string “No. 1” (52) and “No. 14” (54) because it contains events A, C and D in the first, third and fourth positions of the string.

Once event string “No. 24” (56) is identified as a match, the machine readable code identifies the string A-?-C-D as a repetitive pattern. This is a type of interruptible pattern where the second event in the string may be offered as a user-selected variable or action during the invocation of this pattern. Once the user chooses the variable or action, the pattern will be automatically completed.

If consecutive, overlapping event strings are detected as a match, the machine-readable code of this invention will combine the strings in the repetitive pattern. For example, if string A-B-C-D and B-C-D-E are each matched by later-occurring strings, the repetitive pattern presented will be A-B-C-D-E.

In another example of the present invention, a consumer uses telephone banking on a regular basis to check her balance, the last three checks cleared and the last deposit made. Each of these actions requires the consumer to listen to and respond to prompts and then return to the previous voice menu. The bank has the machine-readable code of this invention installed in conjunction with its telephone banking system. After the consumer performs the balance, check cleared status and last deposit the second time, the machine-readable code detects a repetitive pattern associated with her account (or, alternatively, with her phone number if caller ID is incorporated into the system). The third time the consumer uses the telephone banking system, the system queries whether she would like to check her balance, the last three checks cleared and her last deposit. With a single response the consumer obtains all of her information saving both time and consumer aggravation.

A similar use of the present invention can be employed in all currently existing voice-prompt systems, such as customer service, technical assistance and automated ordering systems. This allows the company employing the present invention to service more customers with fewer phone lines, less waiting, faster responses and creates a more efficient system that avoids many of the frustrations experienced by consumers with voice prompt systems.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-readable medium containing instructions for controlling a computer process to enable: a) the recordation of user input and associated computer output; b) the analysis of said input and output to identify a repetitive pattern; and c) the compilation and storage of said identified repetitive pattern for automated replay of the user input portion of said pattern at a later time.

2. The computer-readable medium according to claim 1, wherein said instructions for controlling a computer process further enable the display of a user interface through which a user controls one or more of said recording, analysis, compilation, storage or replay.

3. A system for identifying a repetitive pattern of user input and associated computer output and automating the user input portion of said pattern, said system comprising: a) a computer operative to receive user input from an input device; b) said input device in communication with said computer; and c) software stored on tangible, computer-readable medium in communication with said computer, wherein the software comprises machine readable code that when executed by a processor records said user input and associated computer output; analyzes said user input and computer output to identify a repetitive pattern; compiles and stores said repetitive pattern for replay of the user input portion at a later time.

4. The system according to claim 3, further comprising a display in communication with said computer, wherein said machine readable code provides a user interface outputted to said display through which a user controls one or more of said recording, analysis, compilation, storage or replay.

5. A method for identifying a repetitive pattern of user input and associated computer output and automating the user input portion of said pattern, said method comprising the steps of: a) recording user input from an input device in communication with a computer and associated computer output; b) analyzing said input and output to identify a repetitive pattern; c) compiling and storing said repetitive pattern in a storage device or memory in communication with said computer; and d) replaying the user input portion of said repetitive pattern.

6. The method of claim 5, comprising the additional step of: e) providing a user with a user interface through which the user controls one or more of said recording, analysis, compilation, storage or replay.
